(19) United States
(12) Patent Application Publication
(10) Pub. No.: US 2010/0118902 A1
(43) Pub. Date: May 13, 2010

(54) UNITIZED COOLING MODULE FOR LASER DIODE ARRAY

(75) Inventor: Xin-Yi Wu, Kaohsiung (TW)

Correspondence Address: WPAT, PC;INTELLECTUAL PROPERTY ATTORNEYS, 2030 MAIN STREET, SUITE 1300, IRVINE, CA, 92614, US

(73) Assignee: METAL INDUSTRIES RESEARCH & DEVELOPMENT CENTRE, Kaohsiung (TW)

(21) Appl. No.: 12/346,051

(22) Filed: Dec. 30, 2008

(30) Foreign Application Priority Data
Nov. 12, 2008 (TW) 097143713

(51) Int. Cl. H01S 3/04

(52) U.S. Cl. 372/36

(57) ABSTRACT

The unitized cooling module for a laser diode array of the invention has at least one cooling unit. The cooling unit has an inlet main channel, an outlet main channel, an inlet subchannel, an outlet subchannel and a chamber. The inlet subchannel connects the inlet main channel and the chamber, and the outlet subchannel connects the outlet main channel and the chamber. A heatsink element carrying a laser diode seals the chamber. With a cooling source flowing through the interior of the cooling unit, the heat produced by the laser diode is removed. Thus, the unitized cooling module of the invention is easily assembled, repaired and expanded, and has the effect of pressing fit. Furthermore, the unitized cooling module of the invention can be arranged and designed according to the heat produced by the laser diode to remove the heat from the laser diode, so that the performance of the unitized cooling module is ensured.

### BACKGROUND OF THE INVENTION

1. Field of the Invention

The present invention relates to a cooling module for a laser diode array, in particular, to a unitized cooling module for a laser diode array.

2. Description of the Related Art

A conventional laser diode array mainly adopts an aluminum alloy heatsink module for heat dissipation. However, different heatsink module designs are provided to match the powers of various high power laser diode array.

FIG. 1 is a schematic view of a conventional cooling module. The conventional cooling module 1 includes an aluminum alloy substrate 11 with a plurality of heatsink fins 111 and a fan 12. In the conventional art, a plurality of high power laser diodes 13 is configured on the aluminum alloy substrate 11. The heat produced by the high power laser diodes 13 is conducted to the aluminum alloy substrate 11, and the fan 12 drives air through the heatsink fins 111 so as to dissipate the heat.

The conventional cooling module 1 is only applicable to a low power laser system, and is inapplicable to laser diodes of a high output power or to some special fiber connectors (as the service life of the module is easily shortened). In the conventional art, the heatsink fins 111 are made of an aluminum alloy material. After the laser diodes 13 are powered on, the temperature thereof suddenly rises due to the high current, and thus, the light-emitting quality is unstable.

FIG. 2 is a schematic view of a conventional cooling module for laser diode array with high-density packaging. The conventional cooling module 2 is applied to solve the heat-dissipating problem of a high power laser system having a plurality of laser diodes. Conventionally, the plurality of laser diodes 21 is sintered in an array on one end (hot end) of a heat-dissipating base 22 by means of high-density packaging, and then the cooling module is designed according to the size of the heat-dissipating base 22. The heat-dissipating base 22 has a cooling fluid disposed therein. The heat produced by the laser diodes 21 is first conducted to the cool fluid, then brought to the other end (cold end) of the heat-dissipating base 22 by the cooling fluid, and removed through an external cooling device.

However, the main disadvantage of the conventional high-density packaged cooling module 2 is that the structure thereof is not compact enough, and when the number or stacking manner of the laser diodes 21 is changed, the conventional high-density packaged cooling module 2 must be redesigned correspondingly.

Therefore, there is a need to provide a unitized cooling module to solve the above problem.

### SUMMARY OF THE INVENTION

The present invention is directed to a unitized cooling module for a laser diode array. The module has at least one cooling unit. The cooling unit includes a main body and a heatsink element. The main body has an inlet main channel, an outlet main channel, an inlet subchannel, an outlet subchannel, and a chamber. The inlet subchannel connects the inlet main channel and the chamber, the outlet subchannel connects the outlet main channel and the chamber, and the chamber has an opening. The heatsink element has a first surface and a second surface opposite each other, the first surface seals the opening, and the second surface carries a laser diode.

The unitized cooling module for a laser diode array of the present invention is easily assembled, repaired, and expanded, and has the effect of pressing fit. Furthermore, the unitized cooling module for a laser diode array of the present invention can be arranged and designed according to the heat produced by the laser diode to effectively remove the heat from the laser diode, so as to control the temperature of the laser diode, so that the performance of the laser diode is ensured.

### BRIEF DESCRIPTION OF THE DRAWINGS

FIG. 1 is a schematic view of a conventional cooling module;

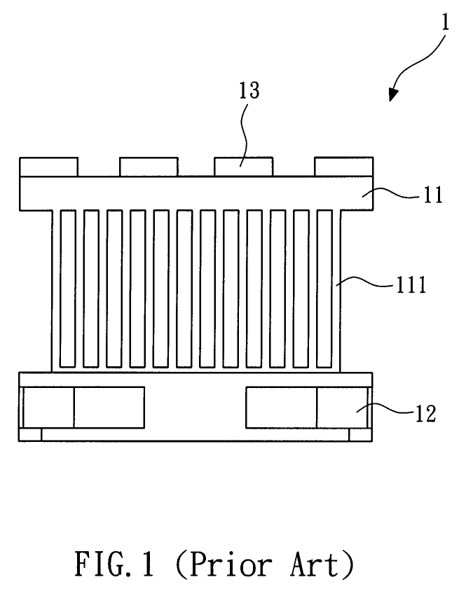

FIG. 2 is a schematic view of a conventional cooling module for high-density packaged laser diode array;

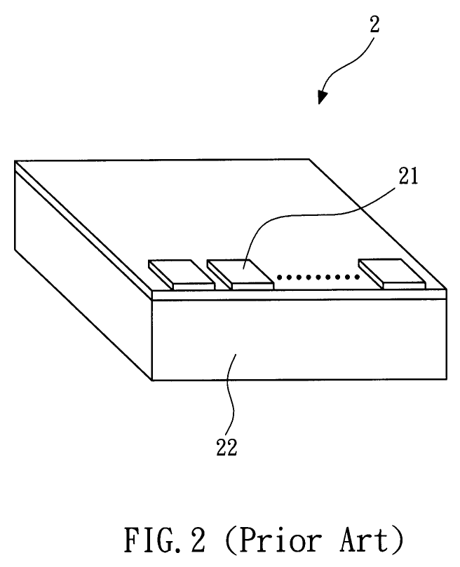

FIG. 3 is a schematic view of a cooling module for a laser diode array according to a first embodiment of the present invention;

FIG. 4 is an exploded view of a cooling unit according to the first embodiment of the present invention;

FIG. 5 is a top view of the cooling unit according to the first embodiment of the present invention;

FIG. 6 is a schematic view of a cooling module for a laser diode array according to a second embodiment of the present invention; and

FIG. 7 is an exploded view of a cooling unit according to the second embodiment of the present invention.

### DETAILED DESCRIPTION OF THE INVENTION

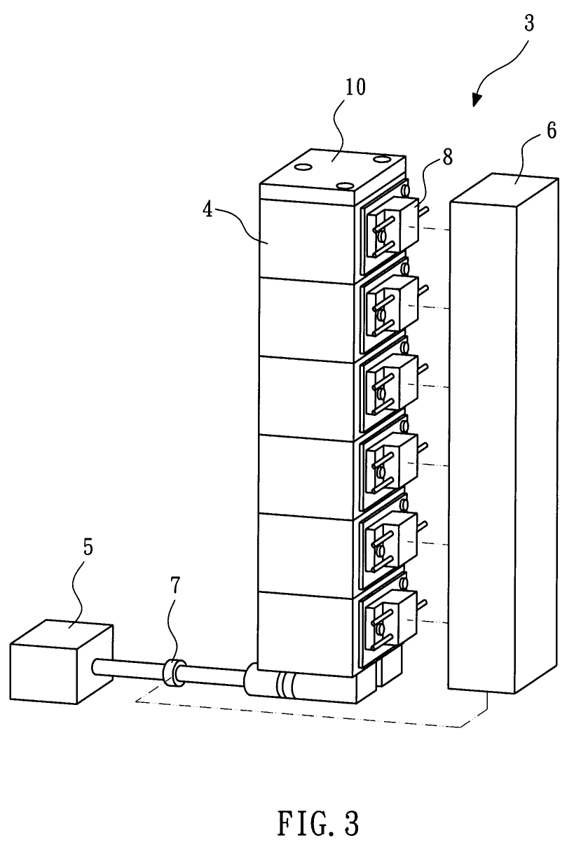

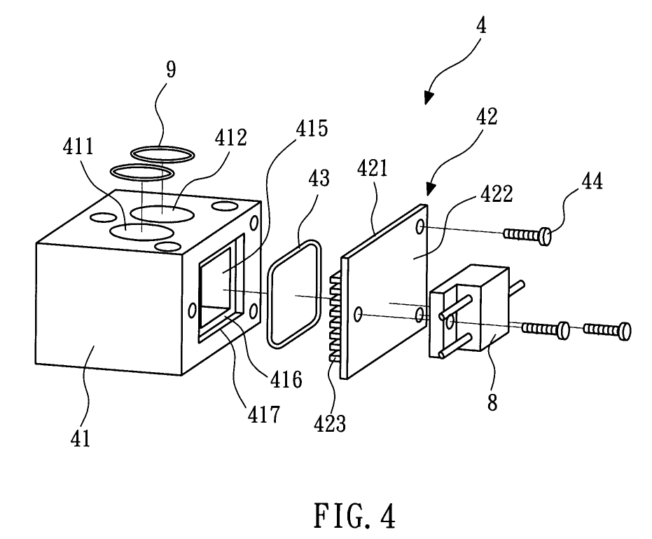

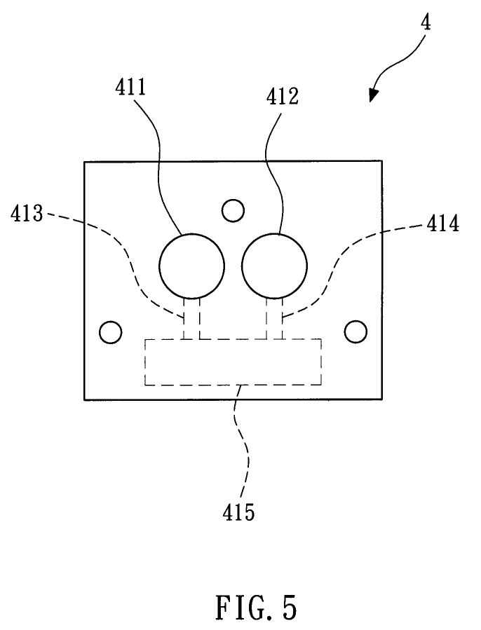

FIG. 3 is a schematic view of a cooling module for a laser diode array according to a first embodiment of the present invention, FIG. 4 is an exploded view of a cooling unit according to the first embodiment of the present invention, and FIG. 5 is a top view of the cooling unit according to the first embodiment of the present invention. As shown in FIGS. 3 and 4, the unitized cooling module for a laser diode array 3 according to the first embodiment of the present invention has a plurality of cooling units 4, a cooling source 5, a sensing device 6, and a flow controller 7.

In this embodiment, the cooling module of the present invention is a stacked cooling module for a laser diode array 3, so as to solve the heat-dissipating problem of a high power laser system having a plurality of laser diodes 8. Each cooling unit 4 is used to cool the corresponding laser diode 8 and keep the temperature of the laser diode 8 within a set range.

As shown in FIGS. 3 to 5, each cooling unit 4 includes a main body 41, a heatsink element 42, a first sealing element 43, and at least one fixing element 44. The main body 41 has an inlet main channel 411, an outlet main channel 412, an inlet subchannel 413, an outlet subchannel 414, a chamber 415, and a disposing region 416. The inlet subchannel 413 connects the inlet main channel 411 and the chamber 415, the outlet subchannel 414 connects the outlet main channel 412 and the chamber 415, and the chamber 415 has an opening 417. The disposing region 416 surrounds the opening 417.

The heatsink element 42 has a first surface 421 and a second surface 422 opposite each other, the first surface 421 seals the opening 417, and the second surface 422 carries the laser diode 8. In this embodiment, the heatsink element 42 includes a plurality of fins 423 disposed on the first surface 421. The fins 423 are disposed in parallel on the first surface 421 along a first direction, and in this embodiment, the first direction is substantially perpendicular to the inlet main channel 411 or the outlet main channel 412. The fins 423 expand the transfer area, and thus improve the heat transfer performance.

The first sealing element 43 is disposed between the disposing region 416 of the main body 41 and the heatsink element 42. In this embodiment, the disposing region 416 is a circular depressed portion, and the shape of the first sealing element 43 matches that of the circular depressed portion. The fixing element 44 is used to fix the laser diode 8 and the heatsink element 42 on the main body 41.

The coolant source 5 is connected to the inlet main channel 411, and in this embodiment the coolant source 5 is a fluid (for example, water). The first sealing element 43 disposed between the disposing region 416 of the main body 41 and the heatsink element 42 is used to prevent the coolant source 5 from leaking. The sensing device 6 is used to measure the temperature of the laser diodes 8.

In this embodiment, the flow controller 7 is disposed between the coolant source 5 and the inlet main channel 411. The flow controller 7 controls the flow of the coolant source 5 according to the temperature of the laser diodes 8 measured by the sensing device 6.

In this embodiment, the unitized cooling module for a laser diode array 3 further includes a plurality of second sealing elements 9 and a cover plate 10. The cooling units 4 are connected by stacking. In particular, the is inlet main channel 411 and the outlet main channel 412 of each cooling unit 4 are correspondingly connected to the inlet main channel 411 and the outlet main channel 412 of the neighboring cooling unit 4. The respective second sealing elements 9 are disposed between the respective neighboring cooling units 4, to prevent the coolant source 5 from leaking.

The cover plate 10 seals the inlet main channel 411 and the outlet main channel 412 on one end of the cooling unit 4, so that the coolant source 5 sequentially flows through the inlet main channel 411, the inlet subchannel 413, the chamber 415, the outlet subchannel 414, and the outlet main channel 412 (a cooling system may be formed with external devices such as a circulating pump, a coolant storage tank, and a heat exchanger), so as to successfully remove the heat conducted to the heatsink element 42 from each laser diode 8.

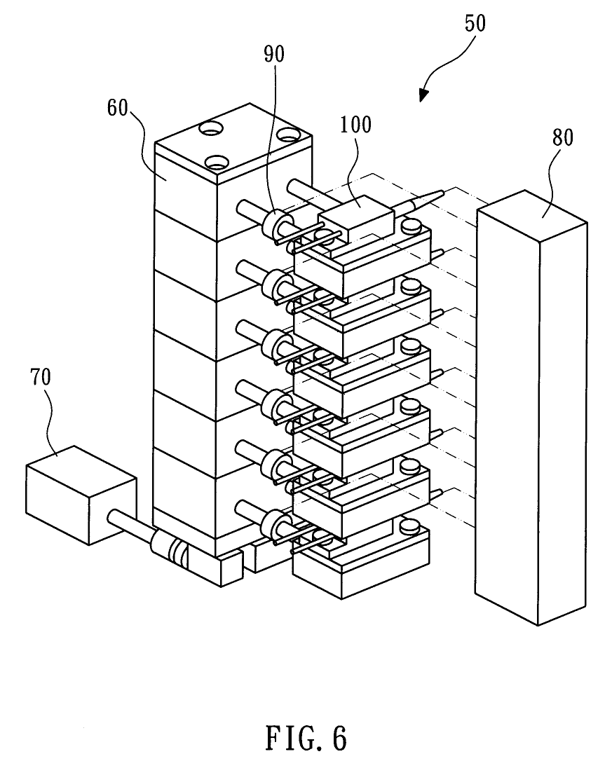

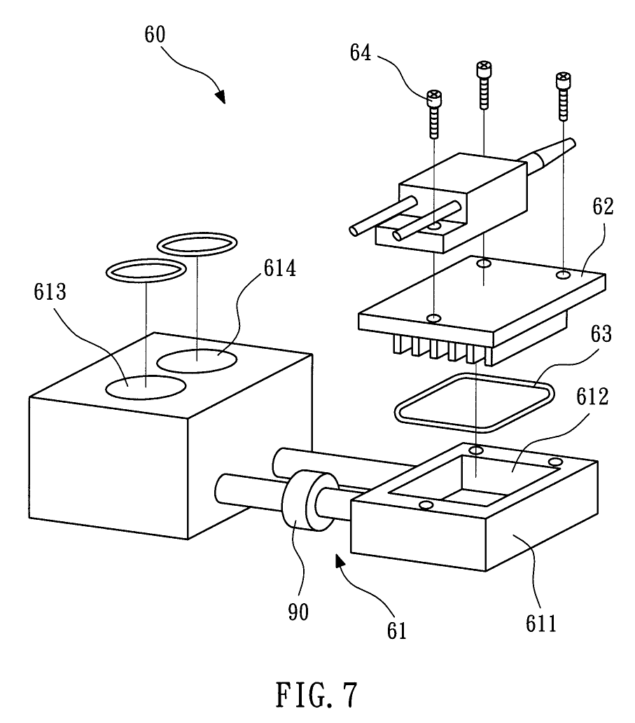

FIG. 6 is a schematic view of a cooling module for a laser diode array according to a second embodiment of the present invention, and FIG. 7 is an exploded view of a cooling unit according to the second embodiment of the present invention. As shown in FIGS. 6 and 7, the unitized cooling module for a laser diode array 50 according to the second embodiment of the present invention has a plurality of cooling units 60, a coolant source 70, a sensing device 80, and a plurality of flow controllers 90. Each cooling unit 60 includes a main body 61, a heatsink element 62, a first sealing element 63, and at least one fixing element 64. In the second embodiment, the main body 61 of each cooling unit 60 further includes an extension portion 611, and a chamber 612 of the cooling unit 60 is disposed in the extension portion 611. Each flow controller 90 is disposed between the chamber 612 and an inlet main channel 613 of each cooling unit 60 (or disposed between the chamber 612 and an outlet main channel 614 of the cooling unit 60). The flow controller 90 controls the flow of the coolant source 70 entering the chamber 612 according to the temperature of a laser 15 diode 100 measured by the sensing device 80. Other components of the unitized cooling module for a laser diode array 50 of the second embodiment are the same as those of the unitized cooling module for a laser diode array 3 of the first embodiment, and the details will not be given herein again.

It should be noted that the unitized cooling module for a laser diode array 50 of the second embodiment may only include a flow controller, and the flow controller may be selectively disposed between the cooling source and the inlet main channel or the outlet main channel of the cooling unit.

In view of the above, the unitized cooling module for a laser diode array of the present invention is easily assembled, repaired, and expanded, and has the effect of pressing fit. Furthermore, the unitized cooling module for a laser diode array of the present invention can be arranged and designed according to the heat produced by a single laser diode or by a high power laser system with a plurality of laser diodes. A flow controller is employed to control the flow of the coolant source according to the temperature of the laser diode measured by the sensing device, so as to control the temperature of the laser diode, so that the performance of the laser diode is ensured.

While the embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications that maintain the spirit and scope of the present invention are within the scope as defined in the appended claims.

What is claimed is:

1. A unitized cooling module for a laser diode array, having at least one cooling unit, the cooling unit comprising:
a main body, having an inlet main channel, an outlet main channel, an inlet subchannel, an outlet subchannel, and a chamber, wherein the inlet subchannel connects the inlet main channel and the chamber, the outlet subchannel connects the outlet main channel and the chamber, and the chamber has an opening; and
a heatsink element, having a first surface and a second surface opposite each other, wherein the first surface seals the opening, and the second surface carries a laser diode.

2. The cooling module according to claim 1, wherein the cooling unit further comprises at least one fixing element for fixing the laser diode and the heatsink element on the main body.

3. The cooling module according to claim 1, wherein the cooling unit further comprises a first sealing element disposed between a disposing region of the main body and the heatsink element, and the disposing region surrounds the opening.

4. The cooling module according to claim 3, wherein the disposing region is a circular depressed portion, and a shape of the first sealing element matches that of the circular depressed portion.

5. The cooling module according to claim 1, wherein the heatsink element comprises a plurality of fins disposed on the first surface.

6. The cooling module according to claim 5, wherein the fins are disposed in parallel on the first surface along a first direction, and the first direction is substantially perpendicular to the inlet main channel or the outlet main channel.

7. The cooling module according to claim 1, further comprising a coolant source connected to the inlet main channel.

8. The cooling module according to claim 7, wherein the coolant source is a fluid.

9. The cooling module according to claim 8, wherein the fluid is water.

10. The cooling module according to claim 7, further comprising a sensing device for measuring a temperature of the laser diode.

11. The cooling module according to claim 10, further comprising a flow controller, disposed between the coolant source and the inlet main channel, for controlling a flow of the coolant source according to the temperature of the laser diode measured by the sensing device.

12. The cooling module according to claim 1, further comprising a plurality of cooling units connected by stacking, wherein the inlet main 15 channel and the outlet main channel of each cooling unit are correspondingly connected to the inlet main channel and the outlet main channel of the neighboring cooling unit.

13. The cooling module according to claim 12, further comprising a plurality of second sealing elements disposed between the neighboring cooling units.

14. The cooling module according to claim 1, wherein the main body further comprises an extension portion, and the chamber is disposed in the extension portion.

15. The cooling module according to claim 14, further comprising a coolant source connected to the inlet main channel.

16. The cooling module according to claim 15, further comprising a sensing device, for measuring a temperature of the laser diode.

17. The cooling module according to claim 16, further comprising a flow controller, disposed between the chamber and the inlet main channel or the outlet main channel, for controlling a flow of the coolant source according to the temperature of the laser diode measured by the sensing device.

18. The cooling module according to claim 14, comprising a plurality of cooling units connected by stacking, wherein the inlet main channel and the outlet main channel of each cooling unit are correspondingly connected to the inlet main channel and the outlet main channel of the neighboring cooling unit.

19. The cooling module according to claim 18, further comprising a plurality of second sealing elements disposed between the neighboring cooling units.
